(19) United States
(12) Patent Application Publication
(10) Pub. No.: US 2020/0117881 A1
(43) Pub. Date: Apr. 16, 2020

(54) TARGET DETECTION METHOD AND DEVICE, UNMANNED AERIAL VEHICLE, AND AGRICULTURAL UNMANNED AERIAL VEHICLE

(71) Applicant: SZ DJI TECHNOLOGY CO., LTD., Shenzhen (CN)

(72) Inventors: Junxi WANG, Shenzhen (CN); Chunming WANG, Shenzhen (CN); Xumin WU, Shenzhen (CN); Renli SHI, Shenzhen (CN)

(21) Appl. No.: 16/713,716

(22) Filed: Dec. 13, 2019

Related U.S. Application Data
(63) Continuation of application No. PCT/CN2017/116888, filed on Dec. 18, 2017.

(51) Int. Cl. G06K 9/00; G05D 1/04; B64C 39/02

(52) U.S. Cl. CPC G06K 9/0063; G05D 1/042; B64C 2201/141; B64C 2201/127; B64C 39/024

(57) ABSTRACT

A method of detecting target signals includes obtaining detection signals from a detection device, the detection device being to detect a target object around an unmanned aerial vehicle, selecting a test signal and neighboring signals from the detection signals, determining a signal threshold corresponding to the test signal according to the neighboring signals, and determining whether the test signal includes a target signal from the target object according to the signal threshold.

### CROSS-REFERENCE TO RELATED APPLICATION

This application is a continuation of International Application No. PCT/CN2017/116888, filed Dec. 18, 2017, the entire content of which is incorporated herein by reference.

### TECHNICAL FIELD

The present disclosure relates to a technical area of unmanned aerial vehicle, and in particular to a target signal detection method and device, and an unmanned aerial vehicle and an agricultural unmanned aerial vehicle regarding the same.

### BACKGROUND

Unmanned aerial vehicles have been employed in a variety of areas, such as aerial photo-imaging, agricultural plant protection, electric power inspection, and disaster relief.

Unmanned aerial vehicles are often equipped with detection devices, such as radar detection devices, time-of-flight (TOF) detection devices, and visual sensors. The unmanned aerial vehicle detects, via the detection device, distance, position, and velocity of a nearby target object relative to the unmanned aerial vehicle.

When conducting detection of a target object, the detection device of the unmanned aerial vehicle may receive noise or interfering signals reflected from the ground surface or the crops on the ground, where the noise reflection signals may interfere with an accurate detection of the target object by the detection device.

### SUMMARY

In accordance with the present disclosure, there is provided a method of detecting target signals including obtaining detection signals from a detection device, the detection device being to detect a target object around an unmanned aerial vehicle, selecting a test signal and neighboring signals from the detection signals, determining a signal threshold corresponding to the test signal according to the neighboring signals, and determining whether the test signal includes a target signal from the target object according to the signal threshold.

Also in accordance with the present disclosure, there is provided an unmanned aerial vehicle including a vehicle body, a power system supported on the vehicle body to provide flight power, a detection device supported on the vehicle body to detect a target object, a flight controller in connection with the power system to providing flight control, and a target signal detection device including a processor configured to perform a method of detecting target signal, where the method includes obtaining detection signals from a detection device, the detection device being to detect a target object around an unmanned aerial vehicle, selecting a test signal and neighboring signals from the detection signals, determining a signal threshold corresponding to the test signal according to the neighboring signals, and determining whether the test signal includes a target signal from the target object according to the signal threshold.

Also in accordance with the present disclosure, there is provided a method of detecting target signals including obtaining a test signal and neighboring signals from a detection device in communication with an unmanned aerial vehicle, where the detection device detects a target object around the unmanned aerial vehicle, and where the neighboring signals include a first number of neighboring signals and a second number of neighboring signals, sending one of the first number of neighboring signals to a sliding window detector at a first timepoint, sending one of the second number of neighboring signals to the sliding window detector at a second timepoint, sending the test signal into the sliding window detector at a third timepoint, where the first timepoint is earlier in time than the third timepoint and the second timepoint is later in time than the third timepoint, determining a signal threshold according to the first and second numbers of the neighboring signals, and determining that the test signal is a valid signal when the test signal is greater than the signal threshold.

### BRIEF DESCRIPTION OF THE DRAWINGS

Objectives, features, and advantages of the embodiments are more readily understandable in reference to the accompanying drawings described below. In the accompanying drawings, the embodiments are described without limiting the scope of the present disclosure.

FIG. 1 is a schematic diagram of an unmanned aerial vehicle according to one embodiment of the present disclosure.

FIG. 2 is a schematic flow chart diagram of processing detection signal according to another embodiment of the present disclosure.

FIG. 3 is a schematic diagram of detecting amplitude of test signals according to yet another embodiment of the present disclosure.

FIG. 4 is a schematic diagram of detecting target signal according to yet another embodiment of the present disclosure.

FIG. 5 is a schematic diagram of communication system employed for detecting target signal according to yet another embodiment of the present disclosure.

FIG. 6 is a schematic diagram of detecting target signal according to yet another embodiment of the present disclosure.

FIG. 7 is a schematic diagram of a sliding window according to yet another embodiment of the present disclosure.

FIG. 8 is a schematic diagram of a sliding window according to yet another embodiment of the present disclosure.

FIG. 9 is a schematic diagram of a sliding window according to yet another embodiment of the present disclosure.

FIG. 10 is a schematic diagram of detecting target signal according to yet another embodiment of the present disclosure.

FIG. 11 is a schematic diagram of a target signal detection device according to yet another embodiment of the present disclosure.

FIG. 12 is a schematic structural diagram of an unmanned aerial vehicle according to yet another embodiment of the present disclosure.

FIG. 13 is a schematic structural diagram of an agricultural unmanned aerial vehicle according to yet another embodiment of the present disclosure.

### DETAILED DESCRIPTION OF THE EMBODIMENTS

The present disclosure is described in view of the embodiments but the embodiments as described do not necessarily limit the scope of any of the claims. To those skilled in the technical art, many suitable changes and improvements may be made to the embodiments. Such suitable changes and improvements are understood to be included in the scope defined by the claims

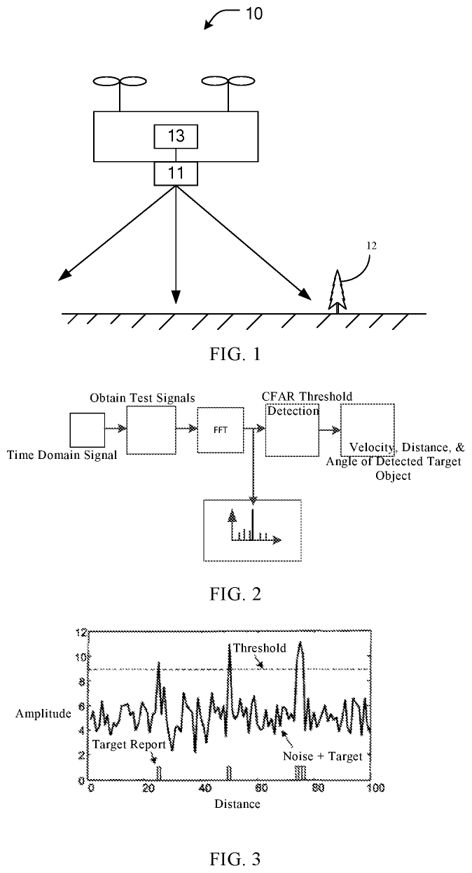

As illustratively depicted in FIG. 1, the unmanned aerial vehicle 10 includes a detection device 11 to detect a target object 12 near or around the unmanned aerial vehicle 10. In some embodiments, the detection device includes a radar detection device, a time of flight (TOF) detection device, an ultrasonic detection device, and visual detection device. The detection device 11 detects the target object 12 below the unmanned aerial vehicle 10, where the target object 12 may be an obstacle or interfering object. The unmanned aerial vehicle includes an agricultural unmanned aerial vehicle.

By way of example, the detection device may be a radar detection device. The radar detection device may be a microwave radar sensor. The microwave radar sensor emits electromagnetic waves. When the target object 12 around the unmanned aerial vehicle 10 receives the electromagnetic waves, the target object reflects the electromagnetic waves to form target signals and particularly target reflection signals. According to the electromagnetic waves emitted by the microwave sensor and the target reflection wave from the target object 12, distance, position of the target object 12 relative to the unmanned aerial vehicle 10 is determined.

The unmanned aerial vehicle 10 may be an agricultural unmanned aerial vehicle. When the agricultural unmanned aerial vehicle conducts operations, the waves emitted by the radar detection device are likely received at the crops and the ground surface, such that many reflection signals received at the radar detection device include detectable noise signals. These noise waves may interfere with detection of the target object 12. To solve this problem, a signal threshold is introduced in the process of detecting target signals reflected from the target object. As illustratively depicted in FIG. 2, the reflection signals received at the radar detection device may be time domain signals, and test signals are obtained from the time domain signals. The test signals may be subject to Fast Fourier Transformation (FFT) processing to become frequency domain signals. Amplitudes of the test signals are obtained from the frequency domain signals. Amplitudes of the test signals may further be subject to Constant False-Alarm Rate (CFAR) threshold detection processing. Amplitude of a test signal is compared to a predetermined threshold. As illustratively depicted in FIG. 3, when the amplitude of the test signal is lower than the signal threshold, the test signal is determined to include only noises and interferences. When the amplitude of the test signal is greater than the signal threshold, the test signal is determined to include target reflection signal from the target object, and a target report is generated. As illustratively depicted in FIG. 2, velocity, distance, and angle of the target object are detected.

There may be certain probability of error associated with method illustratively depicted in FIG. 2 and FIG. 3. For example, strength of spiky signals in the noise may be greater than a signal threshold to cause false detection of target object, or to cause false alarm. When agricultural unmanned aerial vehicle flies at a low or ultra-low altitude, reflection signals received at the detection device may include strong noise signals from the ground, at an extent greater than the detection threshold so as to cause false alarm. To solve this problem, embodiments of the present disclosure provide a target signal detection method, which is to be described in more detail below.

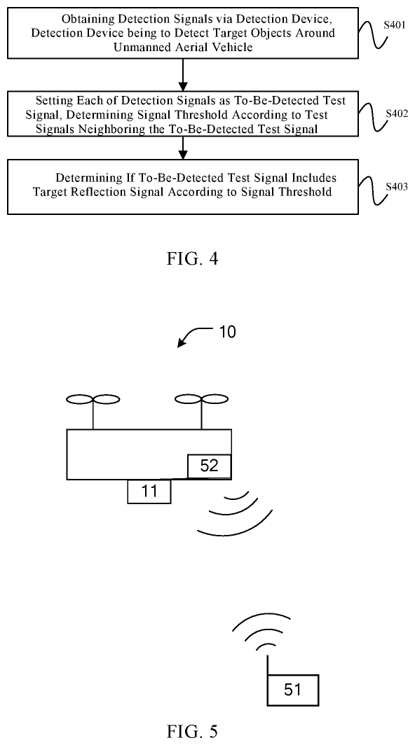

The present disclosure provides a target signal detection method. FIG. 4 is a schematic flow chart diagram of target signal detection method. The method includes the following step(s).

At step S401, multiple detection signals are obtained by a detection device, where the detection device is employed to detect target objects near or around an unmanned aerial vehicle.

The method involves an executive body which may be a processor 13 of the unmanned aerial vehicle 10 as illustratively depicted in FIG. 1. As illustratively depicted in FIG. 1, the processor 13 is in communication with the detection device 11, where the detection device 11 may be a radar detection device or any other suitable detection devices. The detection device 11 is employed to detect target objects around the unmanned aerial vehicle 10, where the unmanned aerial vehicle 10 may be an agricultural unmanned aerial vehicle, and conducting agricultural plant protection operations, the processor 13 obtains in real time a plurality of detection signals of the detection device 11. The detection signals may reflection signals detected by the radar detection device. The detection signals may include target echo signals reflected out by the target objects 12, noise signals reflected out by the plants and/or the ground. The detection signals may only include the noise signals reflected out by the plants and/or the ground.

In certain embodiments, the target signal detection method may be executed by a ground station device 51 as illustratively depicted in FIG. 5, where the ground station device 51 may be remote controller and/or a smart device for controlling the unmanned aerial vehicle.

The unmanned aerial vehicle 10 includes a communication system 52, where the unmanned aerial vehicle 10 sends the detection signals from the detection device 11 down to the ground station device 51 via the communication system 52, and where the ground station device 51 detects reflection signals as reflected out from the target objects. The unmanned aerial vehicle 10 communicates with the ground station device 51 via wired or wireless communications. As illustratively depicted in FIG. 5, the communication system 52 may be in wireless communication with the ground station device 51.

At step S402, a test signal and neighboring signals which are neighbors to the test signal are selected from the detection signals, a signal threshold is corresponding to the test signal is determined according to signal values of the first neighboring signals.

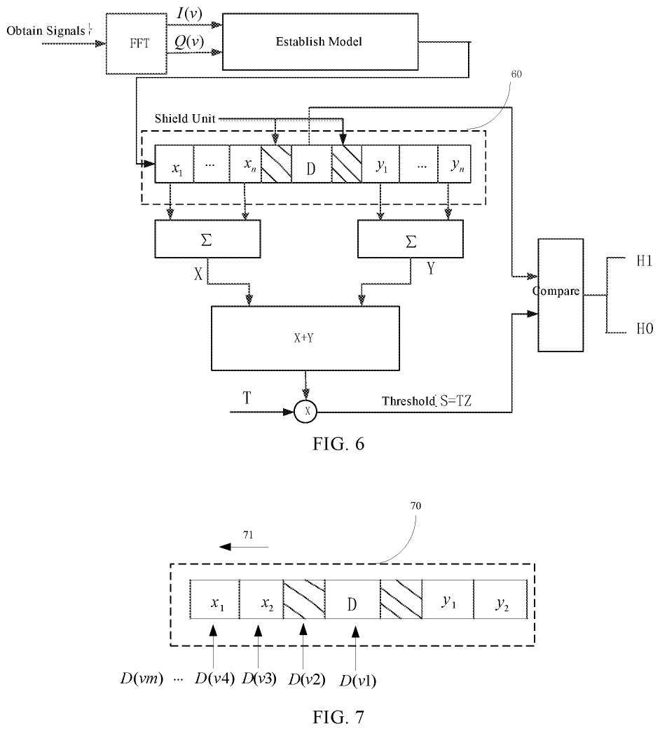

The detection signals detected by the detection device 11 include reflection signals which may be time domain analog signals. The processor 13 may convert the analog signals to digital signals and obtains sampled signals from the digital signals. For example, v(t1), v(t2) . . . and v(tm), represent sampled signals in a number of m, each of which being a test signal. As illustratively depicted in FIG. 6, main part I(v) and supplemental part Q(v) are obtained out of each of the sampled signals via FFT processing and conversion. After FFT processing and conversion, the main and supplemental parts for sampled signal v(t1) are respectively I(v1) and Q(v1), the main and supplemental parts for sampled signal v(t2) are respectively I(v2) and Q(v2), so on and so forth, and the main and supplemental parts for sampled signal v(tm) are respectively I(vm) and Q(vm). Amplitude for each of the sampled signals are obtained according to the main and supplemental parts. Amplitude for sampled signal v(t1) is D(v1)=\sqrt{I²(v1)+Q²(v1)}, amplitude for sampled signal v(t2) is D(v2)=\sqrt{I²(v2)+Q²(v2)}, so on and so forth, and amplitude for sampled signal v(tm) is D(vm)=\sqrt{I²(vm)+Q²(vm)}. Amplitudes of D(v1), D(v2) . . . and D(vm) are further subject to processing via a sliding window 60. The sliding window 60 includes a detection unit D, shield units, reference units x1, x2 . . . , and xn, and reference units y1, y2 . . . , and yn. The sliding window may be a CFAR (Constant False-Alarm Rate) treatment window. The reference units may be of a number of 2n. In some embodiments, the reference units x1, x2, . . . , and xn may be termed front end of the sliding window 60 and the reference units y1, y2, . . . , and yn may be termed back end of the sliding window 60. As illustratively depicted in FIG. 6, one or more shield units may be positioned next to the detection unit D. The one or more shield units as positioned to one side of the detection unit D may be of same or different number in comparison to the one or more shield units positioned to an opposing side of the detection unit D. The shield units work to prevent or reduce signal or data leakage into or out of the detection unit, so as to reduce unwanted interference to noise signal detection. In some embodiments, when radar distance resolution is high enough such that detected objects may occupy multiple units, more than one shield units may be placed one either side of the detection unit D. In some embodiments, n is 2.

As illustratively depicted in FIG. 7, and as the sliding window 70 moves along the arrow direction 71, amplitudes D(v1), D(v2), . . . and D(vm) in turn enters the sliding window 70. When D(v1) enters the detection unit D of the sliding window 70, D(v2) enters the shield unit at a left side of the detection unit D, D(v3) enters the reference unit x2, D(v4) enters the reference unit x1. At this time, x2 may represent D(v3) and x1 may represent D(v4).

As illustratively depicted in FIG. 8, D(v2) enters the detection unit D, D(v1) enters the shield unit at the right side or the other side of the detection unit, D(v3) enters the shield unit at the left side to the detection unit D, D(v4) enters the reference unit x2, and D(v5) enters the reference unit x1. At this time, x2 may represent D(v4) and x1 may represent D(v5).

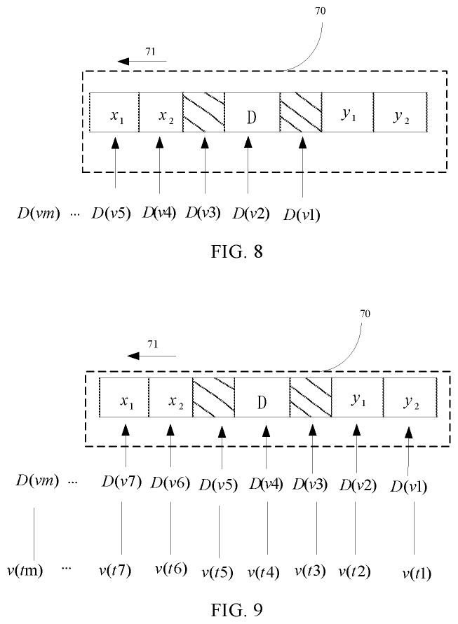

As illustratively depicted in FIG. 9, as D(v4) enters the detection unit D of the sliding window 70, D(v1) enters the reference unit y2, D(v2) enters the the reference unit y1, D(v3) enters the shield unit at the right side to the detection unit D, D(v5) enters the shield unit at the left side to the detection unit, D(v6) enters the reference unit x2, and D(v7) enters the reference unit x1. At this time, x2 represents D(v6), x1 represents D(v7), y1 represents D(v2), and y2 represents D(v1).

Therefore, a new signal or datapoint enters the sliding window every time the slide window moves one unit forward along direction 71 with the arrow shown. As illustratively depicted in FIG. 7 through FIG. 9, each of the detection unit, the shield units, and the reference units represents an amplitude of a sampled signal. However, the units may each represent a signal or value associated with the detection signals, and not necessarily the amplitude of sampled signals after digitization processing of the detection signals. Each of the units in the sliding window corresponds to a sampled signal, and the sliding window conducts processing of a physical value such as the amplitude of the sampled signals. The sampled signal corresponding to the detection unit is a test signal.

As illustratively depicted in FIG. 6 through FIG. 9, for every D(vi) where m the sliding window may capture amplitudes of signals neighboring D(vi), determines the threshold corresponding to D(vi), and then determines if the signal v(ti) corresponding to D(vi) includes target reflection signal according to a comparison between D(vi) and the threshold corresponding to D(vi).

As illustratively depicted in FIG. 7, D(v1) in inside of the detection unit D, while D(v2), D(v3), and D(v4) each are an amplitude of a test signal near the test signal corresponding to D(v1). In some embodiments, an amplitude positioned inside of the shield unit may be excluded from consideration. For example, D(v2) as illustratively depicted in FIG. 7 may not be considered, and only D(v3) and D(v4) are included in the consideration for determining the signal threshold corresponding to D(v1).

As illustratively depicted in FIG. 8, D(v2) is positioned inside of the detection unit D, while D(v1), D(v3), D(v4), and D(v5) are each an amplitude of a test signal near the test signal corresponding to the D(v2). In some embodiments, an amplitude positioned inside of the shield unit may be excluded from consideration. For example, D(v1) and D(v3) as illustratively depicted in FIG. 8 may not be considered, and only D(v4) and D(v5) are included in the consideration for determining the signal threshold corresponding to D(v2). These examples are for illustrations only and are not intended to limit on how the signal threshold may be calculated or determined.

In some embodiments, and according to the test signals neighboring the to-be-detected test signal, the signal threshold particular to the to-be-detected test signal is determined. In particular, estimated strength value of the interfering signals included in the predetermined number of neighboring test signals is determined according to the predetermined number of neighboring test signals neighboring the to-be-detected test signal; thereafter, the signal threshold particular or corresponding to the to-be-detected test signal is determined according to the factor T and also according to the estimated strength value of the interfering signals included in the predetermined number of neighboring test signals.

As illustratively depicted in FIG. 9, D(v1) is an amplitude of test signal v(t1), D(v2) is an amplitude of test signal v(t2), D(v3) is an amplitude of test signal v(t3), D(v4) is an amplitude of test signal v(t4), D(v5) is an amplitude of test signal v(t5), D(v6) is an amplitude of test signal v(t6), and D(v7) is an amplitude of test signal v(t7). Test signals v(t1), v(t2), v(t3), v(t4), v(t5), v(t6), and v(t7) each may include a target reflection signal from a target object or may just include interference signal and/or noise signal. D(v4) is positioned inside of the detection unit. D(v4) corresponds to the test signal v(t4), for which the method is carried out to determine whether the test signal v(t4) includes a target reflection signal of the target object. Prior to determining whether v(t4) includes the target reflection signal from the target object, an estimated value of interference or noise signal corresponding to a predetermined number of neighboring test signals is determined, where the neighboring test signals are test signals near the test signal positioned inside of the detection unit D. For example, when the predetermined number is 4, and when amplitudes positioned inside of the shield unit are not considered, the neighboring test signals that are near the test signal v(t4) are test signal v(t2) corresponding to the backend reference unit y1, test signal v(t1) corresponding to the backend reference unit y2, test signal v(t7) corresponding to the frontend reference unit x1, and test signal v(t6) corresponding to the frontend reference unit x2. According to the test signal v(t2) corresponding to the backend reference unit y1, the test signal v(t1) corresponding to the backend reference unit y2, the test signal v(t7) corresponding to the frontend reference unit x1, and the test signal v(t6) corresponding to the frontend reference unit x2, an estimated value Z on interference signal is determined. Further according to the estimated value Z and a factor T, the signal threshold corresponding to the test signal v(t4) is obtained. The signal threshold also corresponds to D(v4). Via a comparison between D(v4) and the signal threshold corresponding to D(v4), it may be determined as to whether the test signal v(t4) includes the target reflection signal of the target object.

According to the predetermined number of neighboring test signals neighboring the to-be-detected test signal, the step of determining average strength value of noise signal included in the predetermined number of neighboring test signals may include: according to the first predetermined number of neighboring test signals positioned ahead of a test signal further ahead of the to-be-detected test signal, and according to the second predetermined number of neighboring test signals positioned behind of a test signal further behind the to-be-detected signal, an average strength value of the noise signal is determined according to the first and second predetermined numbers of test signals.

As illustratively depicted in FIG. 6, the signal threshold corresponding to the test signal of which the amplitude is positioned inside of the detection unit D is determined according to test signals corresponding to the frontend reference units x1, x2, . . . , and xn, and according to test signals corresponding to the backend reference units y1, y2, . . . , and yn. In this embodiment, the signal threshold is determined according to test signals in the number of 2n, excluding test signals corresponding to the shield units. In particular, and according to a number n of the test signals corresponding to the frontend reference units x1, x2, . . . , and xn, and according to a number n of the test signals corresponding to the backend reference units y1, y2, . . . , yn, an estimate value Z on interference signal strength is determined based on the number n of the test signals corresponding to the frontend reference units x1, x2, . . . , and xn, and based on the number n of the test signals corresponding to the backend reference units y1, y2, . . . , yn. Thereafter, the signal threshold S is determined according to S=T·Z.

As illustratively depicted in FIG. 6, while x1, x2, . . . , and xn, and y1, y2, . . . , and yn are each an amplitude, X is a sum of x1, x2, . . . , and xn, and Y is a sum of y1, y2, . . . , and yn. The estimate value Z, which is determined according to the number 2n of test signals x1, x2, . . . , xn, y1, y2, . . . , and yn, is related to the sum of X+Y. There may be several relationships between Z and X+Y.

One exemplary relationship works like this: the estimate value Z on the interfering signal is determined according to an average of signal strength values corresponding the predetermined number of neighboring test signals, such as number 2n of test signals, where the factor T is related to a false-alarm rate.

The estimated strength value of the interfering signals present in 2n test samples corresponding to the reference units x1, x2, . . . , xn and reference units y1, y2, . . . and yn may be determined according to an average of amplitudes of the 2n test samples, and may be represented by the equation (1) shown below.

$$Z = \frac{1}{R} ( {\sum }_{i = 1}^{n} {x}_{i} + {\sum }_{j = 1}^{n} {y}_{j} ) where \\ R = 2 n , X = {\sum }_{i = 1}^{n} {x}_{i} , Y = {\sum }_{j = 1}^{n} {y}_{j} . \qquad ( 1 )$$

As illustratively depicted in FIG. 6, the signal threshold corresponding to the to-be-detected test signal, the amplitude of which is analyzed inside of the detection unit D, may be represented via the equation S=T·Z , where the factor T is related to the false-alarm rate P_{FA}.

Alternatively, the estimated strength value of the interfering signals present in the predetermined number of neighboring test signals may be determined by a sum strength value of the predetermined number of neighboring test signals. The factor T is related to both the false-alarm rate and the predetermined number.

In particular, the estimated strength value of the interfering signals present in 2n test signals corresponding to the reference units x1, x2, . . . , xn and reference units y1, y2, . . . and yn may be determined according to the sum of amplitudes of the 2n test signals, and may be represented by the equation (2) shown below.

$$Z = {\sum }_{i = 1}^{n} {x}_{i} + {\sum }_{j = 1}^{n} {y}_{j} \qquad ( 2 )$$

where the factor T may be represented by the equation (3) shown below.

T=P_{FA}^{-1/R}−1 (3)

where P_{FA} represents the false-alarm rate.

At step S403, and according to the signal threshold corresponding to the test signal, it is determined as to whether the test signal includes the target reflection signal from the target object.

As illustratively depicted in FIG. 6, the detection unit D corresponds to the test signal, where D represents the signal strength or amplitude of the test signal. A comparison between the signal strength and the signal threshold helps determine as to whether the test signal includes the target reflection signal from the target object.

In some embodiments, and according to the signal threshold corresponding to the to-be-detected signal, the step of determining if the to-be-detected signal includes the target reflection signal includes: when the signal strength of the to-be-detected is greater than the signal threshold, the to-be-detected test signal is determined to include the target reflection signal; when the signal strength of the to-be-detected is smaller than the signal threshold, the to-be-detected test signal is determined to not include the target reflection signal.

In particular, and when D is greater than threshold S, the to-be-detected test signal is determined to include target reflection signal; and when D is smaller or equal to threshold S, the to-be-detected test signal is determined to not include the target reflection signal, or the to-be-detected test signal includes only interference and noise signals, where a relationship between D and S may be represented by equation (4) shown below.

D>T·Z, H₁

D≤T·Z, H₀ (4)

In particular, when D is greater than T·Z , H₁ is established, where H₁ represents that the to-be-detected test signal includes the target reflection signal; and D is smaller than or equal to T·Z , H₀ is established, where H₀ represents that the to-be-detected test signal includes only the interfering and noise signals.

In some embodiments, the method further includes deleting those test signals whose signal strength or amplitude is smaller than or equal to their corresponding signal threshold. In particular, and as illustratively depicted in FIG. 6, amplitude of each of the test signals may be positioned inside of the detection unit D, and the signal threshold corresponding to the each of the test signals may be determined. A comparison between the signal strength and the signal threshold both corresponding to the same test signal helps determine as to whether the test signal includes the reflection signal from the target object. If the test signal is determined to do not include the reflection signal from the target object, that test signal may be deleted or disregarded.

According to embodiment(s) of the present disclosure, multiple detection signals are obtained at the detection device, each of the detection signals is set as the to-be-detected test signal, which is the test signal whose amplitude is placed inside of the detection unit D of the sliding window described herein elsewhere, and according to detection signal near or neighboring the to-be-detected signal, the signal threshold particular and corresponding to the to-be-detected signal is determined. Accordingly, each of the test signals is provided with its own particular signal threshold, instead of a general signal threshold not otherwise particular to any specific test signal. According to its particular and corresponding signal threshold, each of the test signals is better positioned for a determination as to whether the test signal includes the target reflection signal. Accordingly, false alarm is also avoided where a noise signal with signal strength greater than the otherwise general signal threshold does not indeed include the target reflection signal and yet erroneously regarded as a signal including the target reflection signal. Accordingly, detection accuracy of the target object can be increased, and false-alarm rate may be decreased.

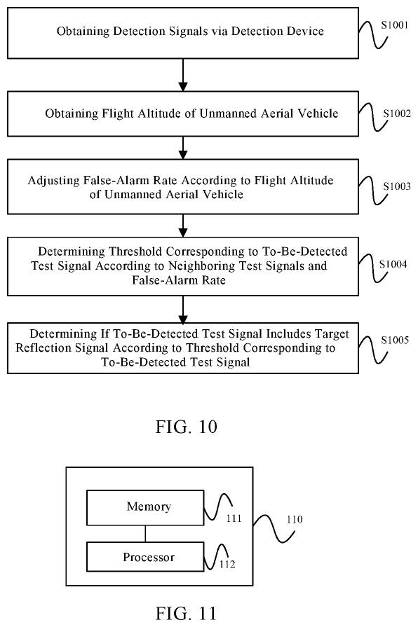

The present disclosure provides a target signal detection method. FIG. 10 is a schematic flow chart diagram of a target signal detection method. As illustratively depicted in FIG. 10, and in view of FIG. 4, the method includes the following step(s).

At step S1001, detection signals are obtained from a detection device, the detection device being employed to detect a target object near or around an unmanned aerial vehicle.

Step S1001 is similar to step S401.

At step S1002, a flight height or flight altitude is obtained from the unmanned aerial vehicle.

As illustratively depicted in FIG. 1, the detection device 11 is able to detect the flight altitude of the unmanned aerial vehicle 10 relative to the ground surface. In some embodiments, multiple detection devices may be supported on the unmanned aerial vehicle 10, such that devices other than the detection device 11 as supported on the unmanned aerial vehicle 10 may be employed to detect the flight altitude of the unmanned aerial vehicle 10 relative to the ground surface.

The processor 13 obtains from the detection device 11 the flight altitude of the unmanned aerial vehicle, or the flight height of the unmanned aerial vehicle relative to the ground surface.

At step S1003, and according to the flight altitude of the unmanned aerial vehicle, a false-alarm rate is adjusted or modified.

The processor 13 adjusts the false-alarm rate according to the flight altitude of the unmanned aerial vehicle 10 relative to the ground surface. As described herein elsewhere, the signal threshold corresponding to the test signal is S=T·Z , where factor T is related to the false-alarm rate P_{FA}. As the false-alarm rate P_{FA} changes, the factor T changes also, and therefore the signal threshold S=T·Z changes accordingly. The false-alarm rate and the signal threshold S=T·Z may be adaptively adjusted according to the flight altitude of the unmanned aerial vehicle.

The step of adjusting the false-alarm rate according to the flight height of the unmanned aerial vehicle may include: when the flight altitude of the unmanned aerial vehicle is greater than a preset altitude, increasing the false-alarm rate; and when the flight altitude of the unmanned aerial vehicle is smaller than the preset altitude, decreasing the false-alarm rate.

In other words, and when the flight altitude of the unmanned aerial vehicle is greater than the preset altitude, the false-alarm rate P_{FA} increases, and the signal threshold S decreases. When the unmanned aerial vehicle such as the agricultural unmanned aerial vehicle is in flight, it becomes less likely for the noise reflection signals from the crops or the ground surface to be captured by the detection device of the unmanned aerial vehicle; therefore, by decreasing the signal threshold S, the likelihood of small objects such as wires in the sky from being overlooked is decreased, and accordingly to reduce missing-alarm rate.

When the flight altitude of the unmanned aerial vehicle is smaller than the preset altitude, the false-alarm rate P_{FA} decreases, and the signal threshold S increases. When the unmanned aerial vehicle such as the agricultural unmanned aerial vehicle is of a relatively low flight altitude, it becomes more likely for the noise reflection signals from the crops or the ground surface to be captured by the detection device of the unmanned aerial vehicle; therefore, by increasing the signal threshold S, the likelihood of the crops and the ground surface from being considered as target objects is decreased, and accordingly to reduce false-alarm rate.

At step S1004, each of multiple detection signals is set as the to-be-detected test signal, the signal threshold of the to-be-detected test signal is determined according to the test signals near or neighboring the to-be-detected test signal and the adjusted or modified false-alarm rate.

The signal threshold particular to the to-be-detected test signal may be expressed as S=T·Z , where factor T is related to the false-alarm rate. When the false-alarm rate P_{FA} changes, factor T changes also, and therefore the threshold S=T·Z changes accordingly too. Z is related to X+Y, where X+Y is determined according to the test signals near or neighboring the to-be-detected test signal. The signal threshold S particular to the to-be-detected test signal can be determined according to the test signals near or neighboring the to-be-detected test signal and according to the adjusted or modified false-alarm rate P_{FA}.

At step S1005, and according to the signal threshold particular to the to-be-detected test signal, it is determined as to whether the to-be-detected test signal includes the target reflected signal.

Step S1005 may be carried out similarly as step S403 both in theory and operation.

When the unmanned aerial vehicle is of a flight altitude greater than the preset altitude, increasing false-alarm rate such that the signal threshold is decreased, which in turn works to reduce the likelihood of small interfering objects such as wires in the sky from being overlooked, and accordingly missing alarm rate is decreased. When the unmanned aerial vehicle is of a flight altitude smaller than the preset altitude, decreasing false-alarm rate such that the signal threshold is increased, which in turn works to reduce the likelihood of crops and other ground surface objects from being regarded as target objects, and accordingly false alarm rate is decreased. Accordingly, missing alarm rate and false alarm rate may be effectively reduced in the process of obstacle avoidance radar detection conducted by the unmanned aerial vehicle, to then reduce impact of noise signals, and to then elevate detection performance on the target objects.

The present disclosure provides a target signal detection device. FIG. 11 is a schematic structural diagram of a target signal detection device. As illustratively depicted in FIG. 11, the target signal detection device 110 includes a memory 111 and a processor 112, where the memory 111 is employed to store program codes or instructions, the processor 112 executes the program codes or instructions to perform certain step(s). The steps may include: obtaining multiple detection signals via a detection device, the detection device being employed to detect a target object near or around an unmanned aerial vehicle; setting each of the multiple detection signals as a to-be-detected test signal and determining the signal threshold corresponding of the to-be-detected test signal according to test signals neighboring the to-be-detected test signal; and determining whether the to-be-detected test signal includes a target reflection signal from a target object according to the signal threshold corresponding to the to-be-detected test signal.

In some embodiments, the detection device includes at least one of a radar detection device, a TOF detection device, an ultrasonic detection device, and a visual detection device.

In some embodiments, the processor 112 determines the signal threshold of the to-be-detected test signal according to the test signals near or neighboring the to-be-detected test signal. Estimated strength value of the interfering signals within the predetermined number of neighboring test signals is determined according to the predetermined number of neighboring test signals near or neighboring the to-be-detected test signal. According to the estimated strength value of the interfering signals within the predetermined number of neighboring test signals, and according to the factor T, the signal threshold corresponding to the to-be-detected test signal is determined.

In some embodiments, the processor 112 determines an estimated strength value of interfering signals present in the predetermined number of neighboring test signals according to the predetermined number of neighboring test signals that neighbor or are near the to-be-detected test signal. According to the first predetermined number of neighboring test signals positioned ahead of a test signal further ahead of the to-be-detected test signal, and according to the second predetermined number of neighboring test signals positioned behind of a test signal further behind the to-be-detected signal, an average strength value of the noise signal is determined according to the first and second predetermined numbers of test signals.

In some embodiments, the estimated value of the strength of the interfering signals is determined according to average strength value of the predetermined number of neighboring test signals.

In some embodiments, the estimated value of the strength of the interfering signals is determined according to the sum strength value of the predetermined number of neighboring test signals. In some embodiments, the factor T is related to the false-alarm rate and the predetermined number.

In some embodiments, the processor 112 determines if the to-be-detected signal includes the target reflection signal from the target object according to the signal threshold of the to-be-detected signal. In particular, when the signal strength of the to-be-detected test signal is determined to be greater than the signal threshold, the to-be-detected signal is determined to include the target reflection signal of the target object; and when the signal strength of the to-be-detected test signal is determined to be smaller than or equal to the signal threshold, the to-be-detected signal is determined to not include the target reflection signal of the target object.

In some embodiments, the processor 112 is further employed to delete or cancel signals as detected by the detection device whose signal strength is smaller than or equal to the signal threshold.

The target detection device mentioned in this embodiment is similar to the target detection device as illustratively depicted in FIG. 4, both in theory and operation.

According to embodiment(s) of the present disclosure, multiple detection signals are obtained at the detection device, each of the detection signals is set as the to-be-detected test signal, which is the test signal whose amplitude is placed inside of the detection unit D of the sliding window described herein elsewhere, and according to detection signal near or neighboring the to-be-detected signal, the signal threshold particular and corresponding to the to-be-detected signal is determined. Accordingly, each of the test signals is provided with its own particular signal threshold, instead of a general signal threshold not otherwise particular to any specific test signal. According to its particular and corresponding signal threshold, each of the test signals is better positioned for a determination as to whether the test signal includes the target reflection signal. Accordingly, also false alarm is avoided where a noise signal with signal strength greater than the otherwise general signal threshold does not indeed include the target reflection signal and yet erroneously regarded as a signal including the target reflection signal. Accordingly, detection accuracy of the target object can be increased, and false-alarm rate may be decreased.

The present disclosure provides a target signal detection device. As illustratively depicted in FIG. 11, the processor 112 is employed to obtain the flight altitude of the unmanned aerial vehicle, and to adjust false-alarm rate according to the flight altitude of the unmanned aerial vehicle.

In some embodiments, the processor 112 adjusts false alarm rate according to the flight altitude of the unmanned aerial vehicle. In particular, when the flight altitude of the unmanned aerial vehicle is greater than the preset altitude, the false-alarm rate is increased; and when the flight altitude of the unmanned aerial vehicle is smaller than the preset altitude, the false-alarm rate is decreased.

The processor 112 determines the signal threshold corresponding or particular to the to-be-detected test signal according to test signals near or neighboring the to-be-detected test signal. In particular, the signal threshold corresponding to the to-be-detected test signal is determined according to the test signals neighboring the to-be-detected test signal and the modified or adjusted false-alarm rate.

The target signal detection device described here may be similar to the device as illustratively depicted in FIG. 10 both in theory and operation.

When the unmanned aerial vehicle is of a flight altitude greater than the preset altitude, increasing false-alarm rate such that the signal threshold is decreased, which in turn works to reduce the likelihood of small interfering objects such as wires in the sky from being overlooked, and accordingly missing alarm rate is decreased. When the unmanned aerial vehicle is of a flight altitude smaller than the preset altitude, decreasing false-alarm rate such that the signal threshold is increased, which in turn works to reduce the likelihood of crops and other ground surface objects from being regarded as target objects, and accordingly false alarm rate is decreased. Accordingly, missing alarm rate and false alarm rate may be effectively reduced in the process of obstacle avoidance radar detection conducted by the unmanned aerial vehicle, to then reduce impact of noise signals, and to then elevate detection performance on the target objects.

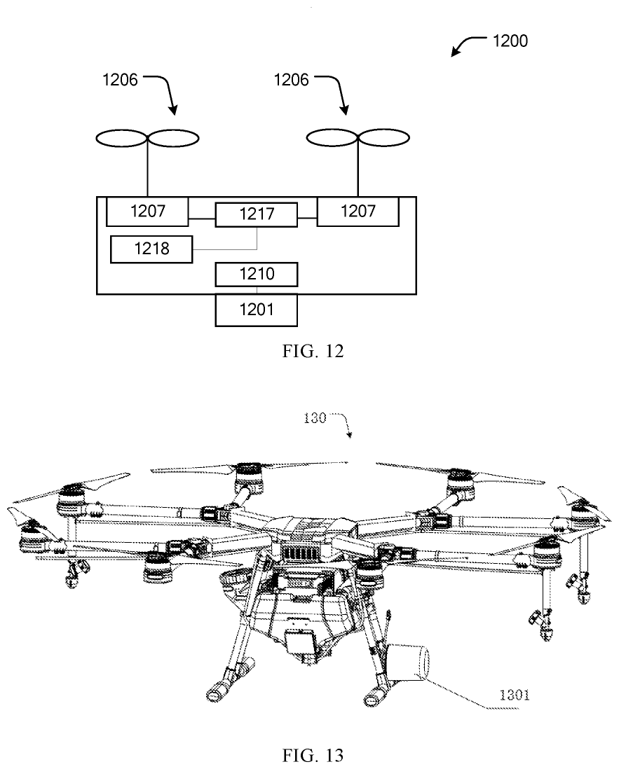

The present disclosure includes an unmanned aerial vehicle. FIG. 12 is a schematic structural diagram of an unmanned aerial vehicle. As illustratively depicted in FIG. 12, the unmanned aerial vehicle 1200 includes a vehicle body, a power system, a detection device 1201, a flight controller 1218, and a target signal detection device 1210. The power system includes at least one of an electric motor 1207, a propeller 1206, and an electric speed regulator 1217, where the power system is positioned and/or supported on the vehicle body to provide flight power, where the detection device 1201 is positioned or supported on the vehicle body to detect target objects near the unmanned aerial vehicle, and where the flight controller 1218 is in communication with the power system to control flight of the unmanned aerial vehicle.

The target signal detection device 1210 may be similar to the target signal detection device 110 both in theory and operation.

According to embodiment(s) of the present disclosure, multiple detection signals are obtained at the detection device, each of the detection signals is set as the to-be-detected test signal, which is the test signal whose amplitude is placed inside of the detection unit D of the sliding window described herein elsewhere, and according to detection signal near or neighboring the to-be-detected signal, the signal threshold particular and corresponding to the to-be-detected signal is determined. Accordingly, each of the test signals is provided with its own particular signal threshold, instead of a general signal threshold not otherwise particular to any specific test signal. According to its particular and corresponding signal threshold, each of the test signals is better positioned for a determination as to whether the test signal includes the target reflection signal. Accordingly, also false alarm is avoided where a noise signal with signal strength greater than the otherwise general signal threshold does not indeed include the target reflection signal and yet erroneously regarded as a signal including the target reflection signal. Accordingly, detection accuracy of the target object can be increased, and false-alarm rate may be decreased.

The present disclosure also provides an agricultural unmanned aerial vehicle. FIG. 13 is a schematic structural diagram of the agricultural unmanned aerial vehicle. As illustratively depicted in FIG. 13, the unmanned aerial vehicle 130 includes a vehicle body, a power system, a detection device 1301, a flight controller, and a target signal detection device. The power system may be supported on the vehicle body to provide flight power. The detection device 1301 may be supported on the vehicle body to detect target object near the unmanned aerial vehicle. The flight controller is in communication with the power system to control flight of the unmanned aerial vehicle. The target signal detection device is consistent with the target signal detection device 110 both in theory and operation.

The detection device 1301 rotates about its rotation shaft and may, for example, conducts continuous rotations. The rotation shaft of the detection device 1301 may be perpendicular to the yaw axis of the agricultural unmanned aerial vehicle, and parallel to the pitch axis of the agricultural aerial vehicle.

In some embodiments, the detection device 1301 is connected to a tripod of the agricultural unmanned aerial vehicle.

According to embodiment(s) of the present disclosure, multiple detection signals are obtained at the detection device, each of the detection signals is set as the to-be-detected test signal, which is the test signal whose amplitude is placed inside of the detection unit D of the sliding window described herein elsewhere, and according to detection signal near or neighboring the to-be-detected signal, the signal threshold particular and corresponding to the to-be-detected signal is determined. Accordingly, each of the test signals is provided with its own particular signal threshold, instead of a general signal threshold not otherwise particular to any specific test signal. According to its particular and corresponding signal threshold, each of the test signals is better positioned for a determination as to whether the test signal includes the target reflection signal. Accordingly, false alarm is also avoided where a noise signal with signal strength greater than the otherwise general signal threshold does not indeed include the target reflection signal and yet erroneously regarded as a signal including the target reflection signal. Accordingly, detection accuracy of the target object can be increased and false-alarm rate may be decreased.

Devices, systems, programs, and methods in actions, orders, steps, and periods, as referenced to in the present disclosure, the claims, and the drawings, may be in any suitable order. In particular, terms such as “first” and “next” may be used to simplify the task of description, but not to imply that such order is necessary.

Several functional units of the embodiments of the present disclosure may be integrated into a processing unit, or may each exist as an independent entity. Each of such units may be presented as a hardware unit or a combination or integration of a hardware and a software.

The software function units may be stored in a computer readable storage medium. The storage medium includes instructions when executed cause to the processor to perform one or more of the steps described herein. Such storage medium may include a U-disk, a mobile hard disk, a read-only memory (ROM), a random-access memory (RAM), and any other suitable storage disks and discs.

The present disclosure is described in view of the embodiments but the embodiments as described do not necessarily limit the scope of any of the claims. Certain embodiments or features of the embodiments described herein may be combined; however, not all such combinations are necessarily required for the solutions to the disclosure. To those skilled in the technical art, many suitable changes and improvements may be made to the embodiments. Such suitable changes and improvements are understood to be included in the scope defined by the claims.

What is claimed is:

1. A method of detecting target signals, comprising:
obtaining detection signals from a detection device, the detection device being to detect a target object around an unmanned aerial vehicle;
selecting a test signal and neighboring signals from the detection signals;
determining a signal threshold corresponding to the test signal according to the neighboring signals; and
determining whether the test signal includes a target signal from the target object according to the signal threshold.

2. The method of claim 1, wherein the detection device includes at least one of a radar detection device, a time-of-flight (TOF) detection device, an ultrasonic detection device, and a visual detection device.

3. The method of claim 1, wherein determining the signal threshold corresponding to the test signal according to the neighboring signals includes:
selecting a predetermined number of neighboring signals;
obtaining a baseline signal strength from the neighboring signals; and
determining the signal threshold according to the baseline signal strength.

4. The method of claim 1, wherein the neighboring signals include a first number of neighboring test signals and a second number of neighboring signals, the method further comprising:
sending one of the first number of neighboring signals to a sliding window detector at a first timepoint;
sending one of the second number of neighboring signals to the sliding window detector at a second timepoint;
sending the test signal into the sliding window detector at a third timepoint, wherein the first timepoint is earlier in time than the third timepoint and the second timepoint is later in time than the third timepoint; and
determining the signal threshold according to the first and second numbers of the neighboring signals.

5. The method of claim 3, wherein the signal threshold is an average signal strength of the predetermined number of neighboring signals.

6. The method of claim 1, wherein determining the signal threshold further includes:
determining the signal threshold further according to a false-alarm rate.

7. The method of claim 3, wherein the signal threshold is a sum signal strength of the predetermined number of neighboring signals.

8. The method of claim 3, wherein the signal threshold is determined further according to a false-alarm rate and the predetermined number.

9. The method of claim 1, wherein determining whether the test signal includes reflection signal from the target object includes:
when a signal strength of the test signal is greater than the signal threshold, determining that the test signal includes the reflection signal of the target object; and
when the signal strength of the test signal is equal to or less than the signal threshold, determining that the test signal does not include the reflection signal of the target object.

10. The method of claim 1, further comprising:
deleting the test signal upon determining that the test signal does not include the reflection signal of the target object.

11. The method of claim 1, further comprising:
obtaining a flight altitude of the unmanned aerial vehicle; and
modifying a false-alarm rate according to the flight altitude of the unmanned aerial vehicle to obtain a modified false-alarm rate.

12. The method of claim 11, wherein modifying the false-alarm rate according to the flight altitude of the unmanned aerial vehicle includes:
increasing the false-alarm rate when the flight altitude of the unmanned aerial vehicle is greater than a preset altitude; and
decreasing the false-alarm rate when the flight altitude of the unmanned aerial vehicle is no greater than the preset altitude.

13. The method of claim 11, wherein determining the signal threshold according to the neighboring signals includes:
determining the signal threshold according to the neighboring signals and the modified false-alarm rate.

14. The method of claim 1, wherein the unmanned aerial vehicle includes an agricultural unmanned aerial vehicle.

15. A method of detecting target signals, comprising:
obtaining a test signal and neighboring signals from a detection device in communication with an unmanned aerial vehicle, wherein the detection device detects a target object around an unmanned aerial vehicle, and wherein the neighboring signals include a first number of neighboring signals and a second number of neighboring signals;
sending one of the first number of neighboring signals to a sliding window detector at a first timepoint;
sending one of the second number of neighboring signals to the sliding window detector at a second timepoint;
sending the test signal into the sliding window detector at a third timepoint, wherein the first timepoint is earlier in time than the third timepoint and the second timepoint is later in time than the third timepoint;
determining a signal threshold according to the first and second numbers of the neighboring test signals; and
determining that the test signal includes a target signal from the target object when the test signal is greater than the signal threshold.

16. The method of claim 15, wherein the sliding window detector is provided to extend long a longitudinal direction and includes a frontend reference unit, a frontend shield unit, a detection unit, a backend shield unit, and a backend reference unit, arranged in this order along the longitudinal direction, the method further comprising:
positioning an amplitude of the test signal inside of the detection unit;
positioning an amplitude of the one of the first number of neighboring signals inside of the backend reference unit; and
positioning an amplitude of the one of the second number of neighboring signals inside of the frontend reference unit.

17. An unmanned aerial vehicle, comprising:
a vehicle body;
a power system supported on the vehicle body to provide flight power;
a detection device supported on the vehicle body to detect a target object;
a flight controller in connection with the power system to providing flight control; and
a target signal detection device including a processor configured to perform:
obtaining detection signals from a detection device, the detection device being to detect a target object around an unmanned aerial vehicle;
selecting a test signal and neighboring signals from the detection signals;
determining a signal threshold corresponding to the test signal according to the neighboring signals; and
determining whether the test signal includes a target signal from the target object according to the signal threshold.
